(19) United States
(12) Patent Application Publication
(10) Pub. No.: US 2021/0156197 A1
(43) Pub. Date: May 27, 2021

(54) TELESCOPIC LADDER ROD UNIT

(71) Applicant: DONGGUAN CASA HOUSEWARES CO., LTD, Dongguan City (CN)

(72) Inventors: Zhu JIN, Dongguan City (CN); Shuyuan LIN, Dongguan City (CN)

(21) Appl. No.: 17/167,667

(22) Filed: Feb. 4, 2021

Related U.S. Application Data
(63) Continuation of application No. PCT/CN2019/083359, filed on Apr. 19, 2019.

(30) Foreign Application Priority Data
Apr. 4, 2019 (CN) 201920454085.9

(51) Int. Cl. E06C 1/12

(52) U.S. Cl. CPC E06C 1/125

(57) ABSTRACT

A telescopic ladder rod unit includes an air cylinder, a fixing seat and a movable plug. The fixing seat is connected to the air cylinder by a connector. A bottom of the fixing seat is disposed with a first mounting portion protruding downwardly. An upper end of the first mounting portion is sleeved with a first sealing ring. A sidewall of the first mounting portion below the first sealing ring is formed with a first air vent. An air passage communicated with the first air vent is disposed in the first mounting portion. A blocking plate is fixed at a lower end of the first mounting portion and formed with a second air vent communicated with the air passage. The movable plug is movably sleeved on the first mounting portion. A sidewall of the movable plug is formed with a first annular groove having a second sealing ring mounted therein.

### TECHNICAL FIELD

The invention relates to the field of telescopic ladder technologies, and more particularly to a telescopic ladder rod unit with cushioning/buffering function.

### DESCRIPTION OF RELATED ART

A telescopic ladder generally is formed by a multi-section left ladder rod, a multi-section right ladder rod, and horizontal plates connected between the left ladder rod and the right ladder rod. A conventional telescopic ladder has no buffering effect when it is retracted, and the ladder rods would be extended and retracted quickly. However, considering that in actual practice, in a process of manually retracting the telescopic ladder, since the telescopic ladder has no buffering effect, the telescopic ladder itself also has a certain weight and an operator has to forcefully retract the telescopic ladder, it is difficult to ensure the retraction strength during the retracting process, which would cause the telescopic ladder to be retracted quickly, so that the operator is easy to pinch her/his hands when retracting the telescopic ladder, the safety performance is low, and therefore it needs to be improved.

### SUMMARY

The objective of the invention is to provide a telescopic ladder rod unit which has a buffering function during retracting and can achieve a high safety performance.

In order to achieve the above objective, the invention proposes technical solutions as follows.

In particular, a telescopic ladder rod unit includes an air cylinder, a fixing seat and a movable plug. The fixing seat is fixedly connected to a bottom of the air cylinder by a connector. A bottom of the fixing seat is disposed with a first mounting portion protruding downwardly, an upper end of the first mounting portion is sleeved with a first sealing ring, a sidewall of the first mounting portion below the first sealing ring is formed with at least one first air vent, and an air passage is disposed in the first mounting portion and communicated with the at least one first air vent. A blocking plate is fixed at a lower end of the first mounting portion, and the blocking plate is formed with at least one second air vent communicated with the air passage. The movable plug is movably sleeved on the first mounting portion and movable up and down, a sidewall of the movable plug is formed with a first annular groove, and a second sealing ring is mounted in the first annular groove. One the telescopic ladder rod unit is capable of being assembled into the air cylinder of a next telescopic ladder rod unit, and multiple the telescopic ladder rod units can be assembled together to form a single ladder rod of a telescopic ladder. After being assembled, the second sealing ring is in contact with the inner wall of the air cylinder of the next telescopic ladder rod unit, a sealing performance between the second sealing ring and the inner wall of the air cylinder is moderate, the movable plug and the air cylinder and the fixing seat of the next telescopic ladder rob unit together form an air chamber.

In an embodiment of the invention, the connector is positioning pins, the fixing seat includes a bottom plate abutting against the bottom of the air cylinder and a second mounting portion extended into the air cylinder, two sides of the second mounting portion are formed with positioning pinholes, a sidewall of a lower end of the second mounting portion is formed with a second annular groove, the air cylinder is formed with round holes corresponding to the positioning pinholes, and the fixing seat and the air cylinder are fixed by the positioning pins passing through the round holes and inserting into the positioning pinholes. A third sealing ring is mounted in the second annular groove, and the third sealing ring abuts against an inner wall of the air cylinder.

In an embodiment of the invention, the first mounting portion is arranged at a central position of the bottom of the fixing seat, a central position of the first mounting portion is disposed with an assembly post with an inner screw hole, the assembly post is connected to an inner wall of the first mounting portion by reinforcing ribs, the inner wall of the first mounting portion and the reinforcing ribs together define the air passage, and the blocking plate is fastened onto a bottom of the first mounting portion by a screw and the assembly post engaged with each other.

In an embodiment of the invention, a contour of the first mounting portion is cylindrical, the least one first air vent is two in amount, and the at least one second air vent is two in amount.

In an embodiment of the invention, a center of the movable plug is formed with an inner hole sleeved on the first mounting portion, the inner hole is a through hole and has a height greater than an outer diameter of the at least one first air vent.

Beneficial effects of the invention can be achieved as follows:

multiple telescopic ladder rod units can be assembled together to form a single ladder rod of a telescopic ladder, during retracting the telescopic ladder, an air pressure in the air chamber pushes the movable plug to move upwardly relative to the first mounting portion until the movable plug abuts against the first sealing ring, the movable plug at this time blocks the first air vent, the air in the air chamber can only be slowly discharged out from the connection position between the second sealing ring and the air cylinder, a cushioning/buffering effect is achieved during retracting the telescopic ladder, and thus it can realize high safety performance and will not hurt operator's hands. In another aspect, during extending the telescopic ladder, an external pressure (e.g., atmospheric pressure) would pushes the movable plug to move downwardly relative to the first mounting portion until the movable plug abuts against the blocking plate, the movable plug leaves away from the first air vent, the external air can quickly enter into the air chamber through the first air vent, the air passage and the second air vent, so that the telescopic ladder can be fast extended and thus is convenient to use.

### BRIEF DESCRIPTION OF THE DRAWINGS

FIG. 1 is a schematic view of an overall structure of a telescopic ladder rod unit according to an embodiment of the invention.

FIG. 2 is a schematic exploded structural view of the telescopic ladder rod unit according to the embodiment of the invention.

FIG. 3 is a schematic structural view of a fixing seat according to the embodiment of the invention.

FIG. 4 is a schematic structural view showing a retracted state of two telescopic ladder rod units assembled together according to the embodiment of the invention.

FIG. 5 is a schematic structure view showing an extended state of two telescopic ladder rod units assembled together according to the embodiment of the invention.

### DETAILED DESCRIPTION OF EMBODIMENTS

The invention will be described below in detail with reference to the accompanying drawings.

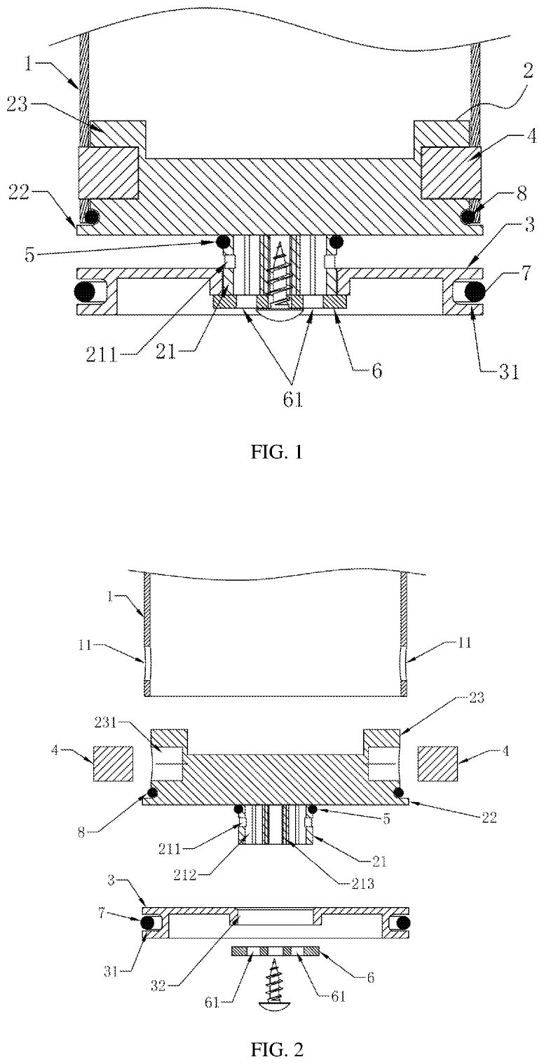

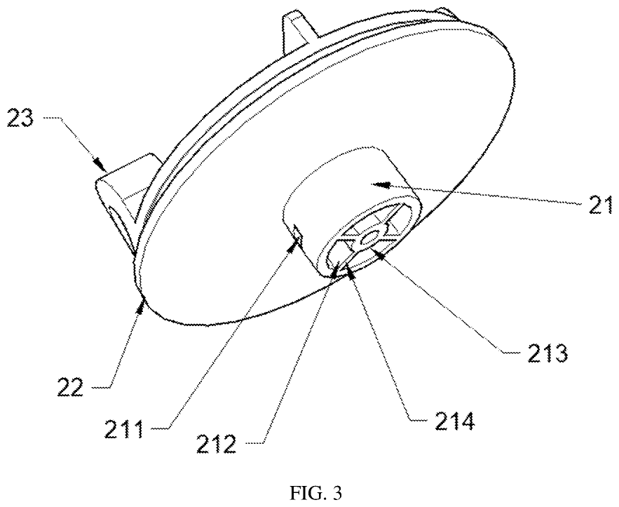

Referring to FIGS. 1-5, a telescopic ladder rod unit (also referred to as rod unit of a telescopic ladder) includes an air cylinder (also referred to as air-filled cylindrical body) 1, a fixing seat 2 and a movable plug 3. The fixing seat 2 is fixedly connected to a bottom of the air cylinder 1 by a connector (also referred to as connection piece) 4. A bottom of the fixing seat 2 is disposed with a first mounting portion 21 protruding therefrom downwardly. An upper end of the first mounting portion 21 is sleeved with a first sealing ring 5. A sidewall of the first mounting portion 21 below the first sealing ring 5 is formed with at least one first air vent 211. An air passage 212 is formed in the first mounting portion 21 and communicated with the first air vent 211. A blocking plate 6 is fixed at a bottom of the first mounting portion 21. The blocking plate 6 is formed with at least one second air vent 61 communicated with the air passage 212. The movable plug 3 is movably sleeved on the first mounting portion 21 and movable up and down. A sidewall of the movable plug 3 is formed with a first annular groove 31. A second sealing ring 7 is disposed in the first annular groove 31. One telescopic ladder rod unit can be assembled into the next one telescopic ladder rod unit, and multiple (i.e., more than one) telescopic ladder rod units can be assembled together to form a single ladder rod of a telescopic ladder. Because each telescopic ladder rod unit is assembled into a next telescopic ladder rod unit, the previous telescopic ladder rod unit has a size smaller than that of the next telescopic ladder rod unit and thus can extend into the air cylinder 1 of the next telescopic ladder rod unit, and after being assembled, the second sealing ring 7 is in contact with an inner wall of the air cylinder 1 of the next telescopic rod unit, the movable plug 3 and the air cylinder 1 and the fixing seat 2 of the next telescopic ladder rod unit together form an air chamber 101. Since the second sealing ring 7 has friction with the inner wall of the air cylinder 1 of the next telescopic ladder rod unit in an extending and retracting process, a sealing performance between the second sealing ring 7 and the inner wall of the gas cylinder 1 is moderate and the second sealing ring 7 should not be pressed too tightly, so that when an air pressure in the air chamber 101 is greater than the external air pressure to a certain extent, the air in the air chamber 101 is capable of being discharged from between the second sealing ring 7 and the inner wall of the air cylinder 1, but the discharge speed is relatively slow.

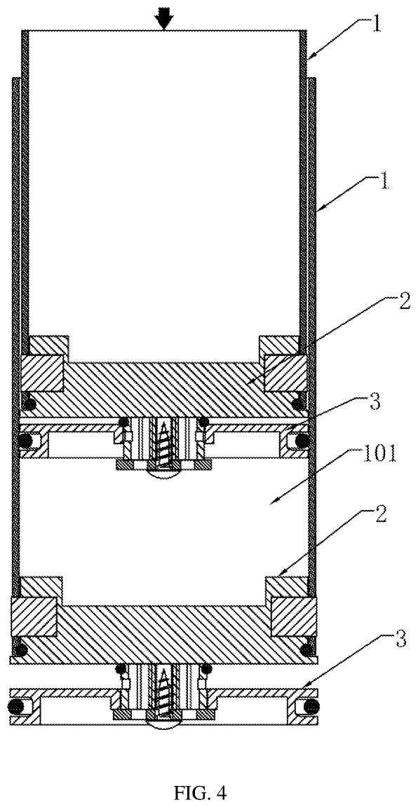

As shown in FIG. 4, during retracting the telescopic ladder, the previous telescopic ladder rod unit moves downwardly relative to the next telescopic ladder rod unit, the air in the air chamber 101 is squeezed and the air pressure rises, the movable plug 3 is pushed upwardly relative to the first mounting portion 21 until abuts against the first sealing ring 5, and at this time the movable plug 3 blocks the first air vent 211 and enhances air tightness cooperative with the first sealing ring 5, the air cannot be discharged from the first air vent 211, so that the air in the air chamber 101 can only be slowly discharged out of the air chamber 101 through the connection position between the second sealing ring 7 and the air cylinder 1 of the next telescopic ladder rod unit, so as to achieve the buffering effect and prevent the injury to the operator during the retracting process.

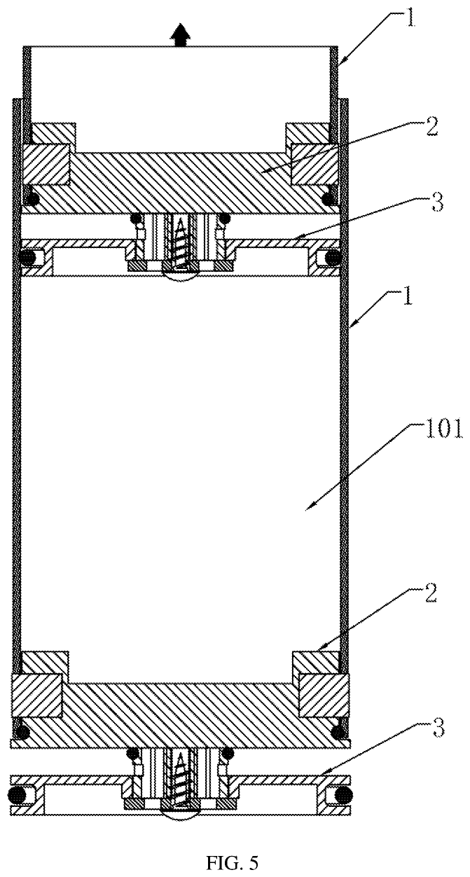

As shown in FIG. 5, during extending the telescopic ladder, the previous telescopic ladder rod unit moves upwardly relative to the next telescopic ladder rod unit, a volume of the air chamber 101 is increased, the air pressure decreases, and the external air pressure pushes the movable plug 3 to move downwardly relative to the first mounting portion 21 until the movable plug 3 abuts against the blocking plate 6, and at this time the movable plug 3 leaves the first air vent 211, the external air can quickly enter into the air chamber 101 through the first air vent 211, the air passage 212 and the second air vent 61, so that the telescopic ladder can be quickly extended, which is convenient to use.

The connector 4 is positioning pins. The fixing seat 2 includes a bottom plate 22 abutted against the bottom of the air cylinder 1 and a second mounting portion 23 extended into the air cylinder 1. The first mounting portion 21 is disposed below the bottom plate 22. Two sides of the second mounting portion 23 are formed with positioning pinholes 231. A side wall of a lower end of the second mounting portion 23 is formed with a second annular groove. The air cylinder 1 is formed with round holes 11 corresponding to the positioning pinholes 231. The fixing seat 2 and the air cylinder 1 are fixed by the positioning pins passing through the round holes 11 and inserting into the positioning pinholes 231 respectively. The second annular groove is mounted a third sealing ring 8 therein. The third sealing ring 8 abuts against the inner wall of the air cylinder 1. The setting of the third sealing ring 8 prevents the air in the air chamber 101 from flowing out from the connection position of the air cylinder 1 and the fixing seat 2, so as to improve air tightness.

A central position of the first mounting portion 21 is formed with an assembly post 213 with an inner screw hole. The assembly post 213 is connected to the inner wall of the first mounting portion 21 by reinforcing ribs 214. The inner wall of the first mounting portion 21 and the reinforcing ribs 214 together define the air passage 212. The blocking plate 6 is fastened onto the bottom of the first mounting portion 21 by a screw and the assembly post 213 engaged with each other, and the structure has high stability.

A contour of the first mounting portion 21 is cylindrical. The at least one first air vent 211 is two in amount, and the at least one second air vent 61 is two in amount. In the illustrated embodiment, the cylindrical contour is employed, but it can also be designed as an elliptical cylinder, polygonal cylinder and so on in actual use. The at least one first air vent 211 is two in amount and the two first air vents 211 are symmetrically arranged, and likewise the at least one second air vent 61 is two in amount and the two second air vents 61 are symmetrically arranged, which are easy to exhaust the air.

A center of the movable plug 3 has an inner hole 32 sleeved on the first mounting portion 21. The inner hole 32 is a through hole and has a height greater than an outer diameter of each the first air vent 211 (in the lengthwise/axial direction of the first mounting portion 21), which facilitates the inner hole 32 can fully block the first air vents 211.

A working principle of the embodiment of the invention is as follows.

During retracting the telescopic ladder, the previous telescopic ladder rod unit moves downwardly relative to the next telescopic ladder rod unit, causing the air in the air chamber 101 is squeezed and the air pressure rises, which pushes the movable plug 3 moves upwardly relative to the first mounting portion 21 until the movable plug 3 abuts against the first sealing ring 5, and at this time the movable plug 3 blocks the first air vents 211 and enhances air tightness cooperative with the first sealing ring 5, the air cannot be discharged from the first air vents 211, and thus the air in the air chamber 101 can only be slowly discharged out of the air chamber 101 through the connection position between the second sealing ring 7 and the air cylinder 1 of the next telescopic ladder rod unit. During extending the telescopic ladder, the previous telescopic ladder rod unit moves upwardly relative to the next telescopic ladder rod unit, the volume of the air chamber 101 is increased, the air pressure decreases, so that the external air pressure pushes the movable plug 3 to move downwardly relative to the first mounting portion 21 until the movable plug 3 abuts against the blocking plate 6, and at this time the movable plug 3 leaves away from the first air vents 211, the external air can quickly enter into the air chamber 101 through the first air vents 211, the air passage 212 and the second air vents 61, and therefore the telescopic ladder can be fast extended.

The above description does not limit the technical scope of the invention. Any modification, equivalent substitution and improvement made to the above embodiments according to the technical essence of the invention are all included in the scope of the technical solution of the invention.

What is claimed is:

1. A telescopic ladder rod unit, comprising: an air cylinder, a fixing seat and a movable plug;
wherein the fixing seat is connected to a bottom of the air cylinder by a connector, a bottom of the fixing seat is disposed with a first mounting portion protruding therefrom downwardly, an upper end of the first mounting portion is sleeved with a first sealing ring, a sidewall of the first mounting portion below the first sealing ring is formed with at least one first air vent, and an air passage is disposed in the first mounting portion and communicated with the at least one first air vent;
wherein a blocking plate is fixed at a lower end of the first mounting portion, and the blocking plate is formed with at least one second air vent communicated with the air passage;
wherein the movable plug is movably sleeved on the first mounting portion and movable up and down, a sidewall of the movable plug is formed with a first annular groove, and a second sealing ring is mounted in the first annular groove.

2. The telescopic ladder rod unit as claimed in claim 1, wherein the connector is positioning pins, the fixing seat comprises a bottom plate abutted against the bottom of the air cylinder and a second mounting portion extended into the air cylinder, two sides of the second mounting portion are formed with positioning pinholes, a sidewall of a lower end of the second mounting portion is formed with a second annular groove, the air cylinder is formed with round holes corresponding to the positioning pinholes, the fixing seat and the air cylinder are fixed by the positioning pins passing through the round holes and inserting into the positioning pinholes, a third sealing ring is mounted in the second annular groove, and the third sealing ring abuts against an inner wall of the air cylinder.

3. The telescopic ladder rod unit as claimed in claim 1, wherein the first mounting portion is arranged at a central position of the bottom of the fixing seat, a central position of the first mounting portion is disposed with an assembly post with an inner screw hole, the assembly post is connected to an inner wall of the first mounting portion by reinforcing ribs, the inner wall of the first mounting portion and the reinforcing ribs together define the air passage, and the blocking plate is fastened onto a bottom of the first mounting portion by a screw and the assembly post engaged with each other.

4. The telescopic ladder rod unit as claimed in claim 1, wherein a contour of the first mounting portion is cylindrical, the least one first air vent is two in amount, and the at least one second air vent is two in amount.

5. The telescopic ladder rod unit as claimed in claim 1, wherein a center of the movable plug is formed with an inner hole sleeved on the first mounting portion, the inner hole is a through hole and has a height greater than an outer diameter of the at least one first air vent.
